(19) United States
(12) Patent Application Publication
(10) Pub. No.: US 2008/0005516 A1
(43) Pub. Date: Jan. 3, 2008

(54) Memory power management through high-speed intra-memory data transfer and dynamic memory address remapping

(76) Inventors: Robert J. Meinschein, Tigard, OR (US); Sai P. Balasundaram, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/479,378

(22) Filed: Jun. 30, 2006

(51) Int. Cl. G06F 13/00

(52) U.S. Cl. 711/165

(57) ABSTRACT

A method, circuit, and system are disclosed. In one embodiment, the method comprises designating a contiguous portion of the physical memory in one or more dual in-line memory modules (DIMMs) to be powered down, locking the designated portion of memory to halt memory operations between the memory and any device that requests access to the designated portion of memory, relocating any data currently residing in the designated portion of the one or more DIMMs to one or more locations in the non-designated portion of the one or more DIMMs, and powering down the designated portion of the one or more DIMMs.

### FIELD OF THE INVENTION

The invention relates to power management of the memory subsystem in a computer system.

### BACKGROUND OF THE INVENTION

A projected increase in minimum recommended memory for laptops, coupled with future dynamic random access memory (DRAM) devices with higher densities will increase the power consumption of system memory. Memory power management will be a key technology to save overall system power by reducing memory power consumption, thereby extending battery life or reducing thermal problems associated with memory. Additionally, on server platforms, memory consumes a significant portion of overall system power because servers have higher number of dual in-line memory modules (DIMMs) and the power per DIMM is also significantly higher. It would be beneficial to allow for dynamic power management of DIMMs within servers and laptops when certain portions of memory are idle.

Operating systems are largely unaware of the physical layout of main memory. They view memory as a linear address space. In reality, contiguous addresses are not contiguous in DRAM and this is due to address interleaving in certain types of memory such as, for example, double data rate (DDR) DIMMs. With address interleaving, contiguous addresses may reside on different memory nodes. In different embodiments, a memory node may be a memory device, a rank, or an entire DIMM. Before powering off a node, data from that node has to be relocated to other nodes. Only the memory controller is intimately aware of node boundaries, address interleaving, etc.

### BRIEF DESCRIPTION OF THE DRAWINGS

The present invention is illustrated by way of example and is not limited by the figures of the accompanying drawings, in which like references indicate similar elements, and in which:

FIG. 1 is a block diagram of a computer system which may be used with embodiments of the present invention.

FIG. 2 describes one embodiment of the memory subsystem in the computer system described in FIG. 1.

FIGS. 3 and 4 illustrate one embodiment of the movement of blocks of memory from locations within a power down targeted node, to a non-targeted node.

FIG. 5 illustrates one embodiment of the changes in the address mapping scheme from before relocation to after relocation.

FIG. 6 is a flow diagram of one embodiment of a process to relocate data within memory to allow for a node to be powered down.

FIG. 7 is a flow diagram of another embodiment of a process to relocate data within memory to allow for a node to be powered down.

### DETAILED DESCRIPTION OF THE INVENTION

Embodiments of a method, apparatus, and system to manage memory power through high-speed intra-memory data transfer and dynamic memory address remapping are disclosed. In the following description, numerous specific details are set forth. However, it is understood that embodiments may be practiced without these specific details. In other instances, well-known elements, specifications, and protocols have not been discussed in detail in order to avoid obscuring the present invention.

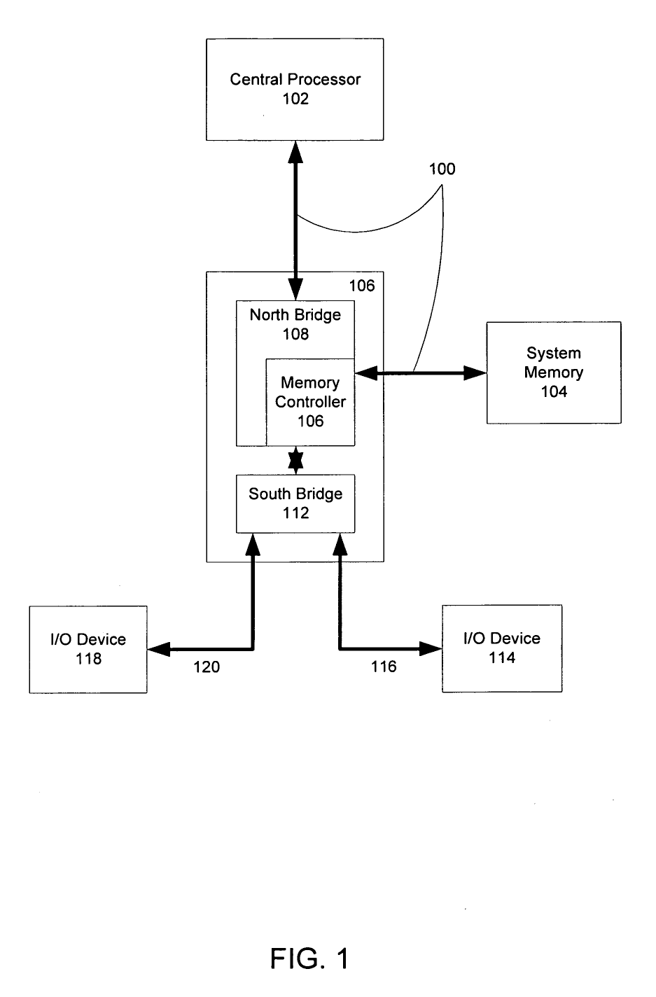

FIG. 1 is a block diagram of a computer system which may be used with embodiments of the present invention. The computer system comprises a processor-memory interconnect 100 for communication between different agents coupled to interconnect 100, such as processors, bridges, memory devices, etc. Processor-memory interconnect 100 includes specific interconnect lines that send arbitration, address, data, and control information (not shown). In one embodiment, central processor 102 is coupled to processor-memory interconnect 100. In another embodiment, there are multiple central processors coupled to processor-memory interconnect (multiple processors are not shown in this figure).

Processor-memory interconnect 100 provides the central processor 102 and other devices access to the system memory 104. A system memory controller 106 controls access to the system memory 104. In one embodiment, the system memory controller is located within the north bridge 108 of a chipset 106 that is coupled to processor-memory interconnect 100. In another embodiment, a system memory controller is located on the same chip as central processor 102 (not shown). Information, instructions, and other data may be stored in system memory 104 for use by central processor 102 as well as many other potential devices. I/O devices, such as I/O devices 114 and 118, are coupled to the south bridge 110 of the chipset 106 through one or more I/O interconnects 116 and 120.

In one embodiment, the computer system in FIG. 1 has power management capabilities for the system memory 104. These capabilities allow portions or all of the system memory 104 to be put into a low power state or turned off altogether when they are idle. In different embodiments, the system memory controller 106 may have the capability to turn the power to system memory off entirely, turn the power off to a single dual in-line memory module off, turn the power off to a single system memory rank (one side of a DIMMs), turn the power off to a single memory device located in one rank of system memory, turn the power off to a single bank of system memory that spans one or more memory devices, turn the power off to a portion of a single memory device, or any one or more possible power implementations within a system memory subsystem. Additionally, the system memory controller may not completely power down a portion of system memory and rather may just cause the portion to enter a more power efficient state.

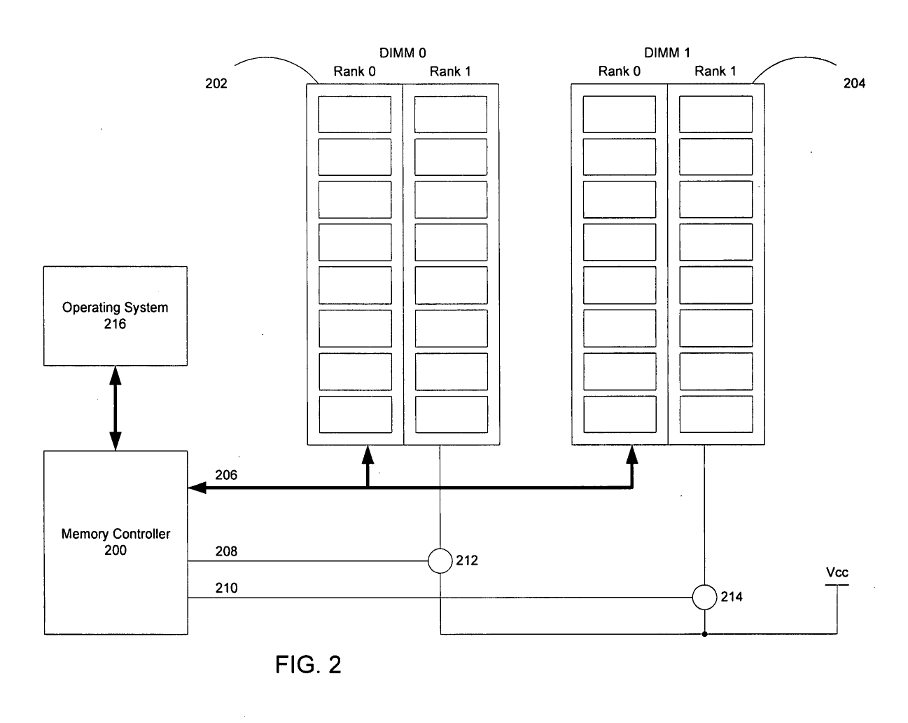

FIG. 2 describes one embodiment of the memory subsystem in the computer system described in FIG. 1. In this embodiment, the memory controller 200, just as in FIG. 1, resides within the north bridge of the chipset in the computer system. This memory controller 200 provides access to the DIMMs (DIMM 0 (202) and DIMM 1 (204)) through an interconnect 206. The interconnect allows data and control information to be sent between the memory controller 200 and DIMMs 0 and 1 (202 and 204).

Furthermore, in this embodiment, power management interconnects (208 and 210) couple the memory controller 200 to memory power management modules 212 and 214. Memory power management module 212 is coupled to DIMM 0 (202) and memory power management module 214 is coupled to DIMM 1. Both memory power management modules (212 and 214) are also connected to a voltage supply (Vcc) that supplies the necessary power to both DIMMs. Memory power management modules 212 and 214 supply each DIMM with the needed power to operate. These modules are also able to limit the power supplied to the DIMMs in lower power states as well as cut off the supply of power to the DIMMs altogether when one needs to be powered down. Thus, in different embodiments, the modules comprise power circuitry, logic, have stored power management software, or have a combination of all three.

In different embodiments, the modules have the ability to control power individually to each DIMM, or to each rank within the DIMM, or to each device located on the DIMM, or to a portion of each device on each DIMM. Each individually powered portion of the entire memory subsystem will be referred to as a node. For a node to be independent, there must be an ability to isolate the power supplied to that node apart from any other portion of the memory subsystem. Thus, in different embodiments, the granularity of the power management control is dependent upon the size of each node. In certain systems, a node may be an entire DIMM, in other systems, a node may be only a portion of an individual device on a DIMM.

In the illustrated embodiment of FIG. 2, one module controls an entire DIMM, thus each power node is an entire DIMM. Additionally, FIG. 2 shows the memory power management modules, 212 and 214, as being discrete devices residing between the memory controller 200 and the DIMMs (202 and 204). In another embodiment, the modules reside within the memory controller 200 (not shown). In yet another embodiment, the modules reside within the circuitry in each DIMM.

To turn off the power to a node, the memory controller 200 sends one or more power management controls to either memory power management module 212 or 214. Once power is turned off to a DIMM node, the data that is stored in the memory space within the DIMM is invalid, thus it is imperative to move any valid data out of the memory space of the node designated for having the power shut off. In a standard environment, the central processor (102 in FIG. 1) and any host bus controllers coupled to one or more additional interconnects (116 and 120 in FIG. 1) are the devices that request direct access to read from and write to physical memory on the DIMMs. In the present embodiment, if a node DIMM is designated to be turned off, the memory controller sends data directly from that DIMM to another location on a second DIMM that remains powered. In another embodiment, if the nodes are smaller than an entire DIMM, the memory controller 200 may also send data directly between two locations on the same DIMM, where the location being read from is within the node to be powered down and the location being written to is not within the powered down node. Thus, in this embodiment, no devices external to the memory subsystem (i.e. the memory controller and the one or more DIMMs) see any memory traffic.

In one embodiment, a table of power managed nodes is maintained by the memory controller 200. Each entry of the table has the starting physical address of the node and the size of the node. In this embodiment, an operating system (OS) 216 (or virtual machine manager (VMM) in another embodiment) access to this table and is able to determine whether one or more nodes can be powered down by checking to see if there is enough empty space available in memory outside of the node targeted for power down to span one or more nodes. If there is enough free space available, the OS 216 may initiate a node power down sequence.

In one embodiment, the free pages within memory that, when combined, are able to span one or more memory nodes are scattered throughout memory. Thus, in one embodiment, the node power down sequence begins with the OS 216 gathering free memory pages scattered throughout memory to create one or more physically contiguous blocks equal to at least the size of the node that is to be powered down. The OS 216 locks this contiguous block of locked memory. The OS 216 aligns this locked block of memory at the starting physical address of the target node and informs the memory controller when completed. The OS 216 actually resides within the memory in the system, block 216 is just a representation for ease of explanation.

Once the memory controller is informed by the OS 216 that the block has been created and aligned at the starting physical address of the target node, the memory controller 200 moves all memory pages from the target node to other nodes in the table through high-speed intra-memory data transfer. This is required because although the free memory blocks are contiguous in physical address space, at the actual DIMM level, the blocks are dispersed across banks, ranks, and DIMMs due to address interleaving. The memory controller 200 then aligns the block of locked memory at the boundary of the target node. The memory controller 200 then remaps all addresses by modifying the address translation to reflect the new configuration of operating nodes (i.e. eliminating address translations that would map into the targeted node in physical memory). The target node is then powered off. In one embodiment, the memory controller 200 sends a power down signal to the memory power management module that manages the power delivery to the targeted node.

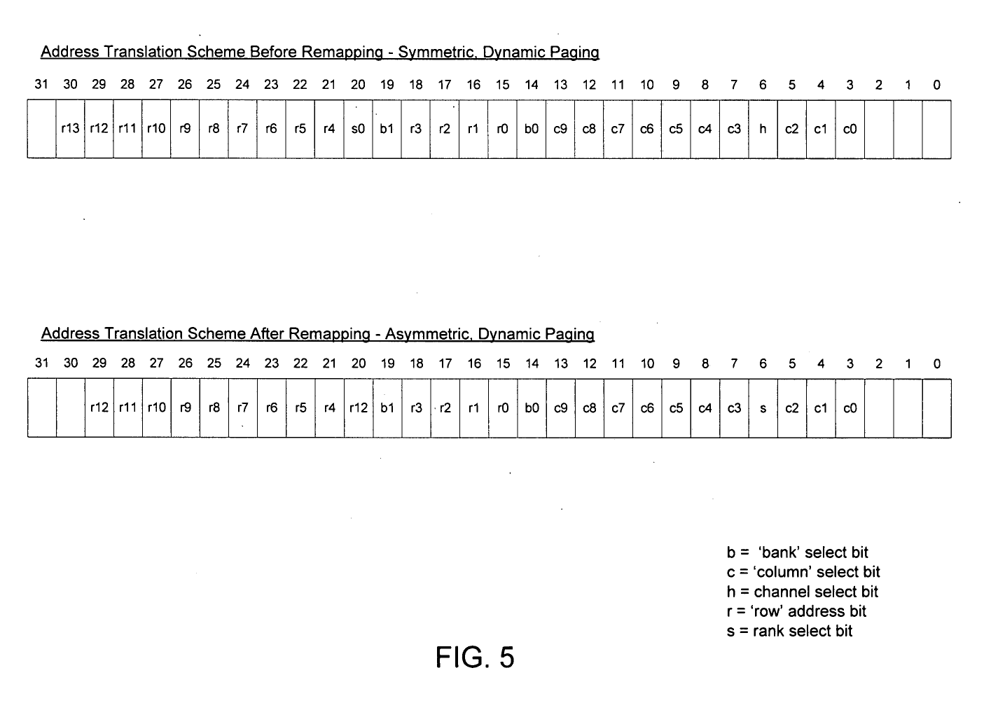

In one embodiment, the memory controller's movement of all memory pages between the target node and non-target nodes occurs without the knowledge of the OS 216. The OS need not be aware of the physical layout of memory due to interleaved addressing. Rather, the memory controller can reposition and remap memory directly between nodes in the one or more DIMMs with high-speed intra-DIMM and inter-DIMM memory transfers that never are seen by any device or operating system beyond the memory controller. Thus, as far as the OS 216 is concerned, the contiguous block of memory that it created is actually contiguous at the DIMM level as well. The memory controller is the only device that requires knowledge of the interleaving between banks, ranks, and full DIMMs. Furthermore, once the memory pages have been relocated to the non-targeted nodes, the memory controller dynamically modifies the address mapping scheme so that the targeted node is no longer accessible by OS 216, but the non-targeted nodes remain fully accessible and operational. Below, FIG. 5 describes in detail one embodiment of an address remapping scheme.

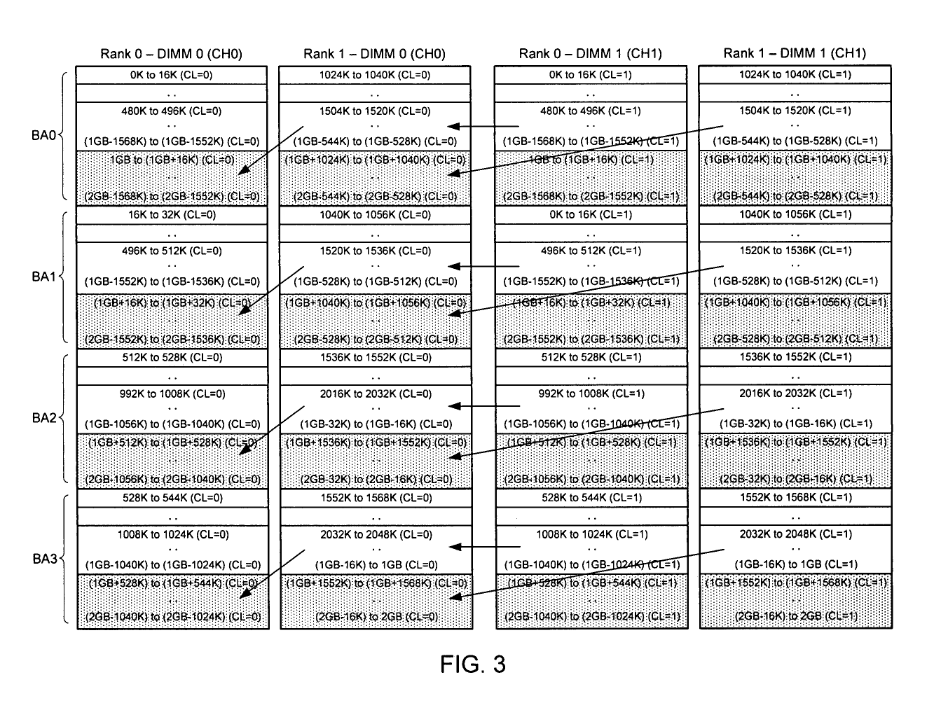

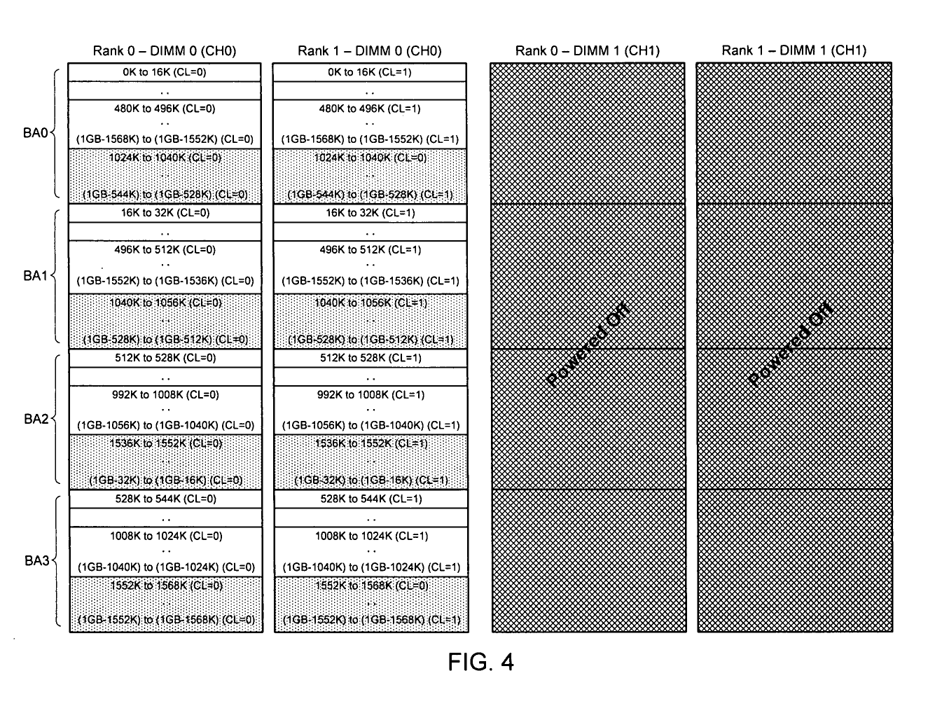

FIGS. 3 and 4 illustrate one embodiment of the movement of blocks of memory from locations within a power down targeted node, to a non-targeted node. In this embodiment, two 1 GB DIMMs reside in the computer system for a total of 2 GB of memory. Each DIMM has two ranks, with 512 MB on each rank. In this embodiment, there is more than 1 GB of free memory when the computer system is idle. In this embodiment, the memory controller is running in a dual channel (symmetric) mode with enhanced addressing (or dynamic paging) turned on. In this embodiment, the memory controller maintains and provides a table of nodes that can be independently power managed. One of the entries in this table represents DIMM 1 (DIMM 1 in FIG. 3), with a starting physical address of 1 GB and size 1 GB.

In this embodiment, an operating system determines that there is at least 1 GB of free memory. The operating system coalesces pages and creates a contiguous 1 GB block of locked memory aligned at the 1 GB boundary (the upper half of memory). Although, from the operating system's point of view, the 1 GB block of locked memory is contiguous, in actual physical memory the 1 GB block spans both DIMMs due to interleaving. In the dual channel mode (symmetric addressing), the block spans both ranks of both DIMMs, which is illustrated in FIG. 3. The shaded blocks represent the 1 GB of locked memory aligned at the 1 GB boundary. The white blocks represent memory that is in use.

In one embodiment, a request is sent to the memory controller to power off the target node. In one embodiment, the operating system requests this because it knows there is enough free memory to power off a node. In response to the request, the memory controller relocates all blocks of memory currently in use (white blocks in FIG. 3) that reside in DIMM 1 to locations occupied by free blocks on DIMM 0 (shaded blocks in FIG. 3). In one embodiment, this data transfer is handled internally between the memory controller and the DIMMs, completely independent of the CPU, caches, and the operating system. In one embodiment, all currently used memory blocks that originally resided in any location in DIMM 0 now reside in rank 0 of DIMM 0 and all currently used memory blocks that originally resided in DIMM 1 now reside in rank 1 of DIMM 0. The relocation of the blocks of memory. The resulting memory usage is shown in FIG. 4. After the memory relocation, DIMM 1 only contains blocks that belong to the region locked by the OS as illustrated in FIG. 4.

The memory controller then remaps addresses by switching the address translation scheme. Additionally, the memory controller switches addressing mode to ‘asymmetric’ to allow for blocks of memory to be independently populated instead of having memory interleaved between DIMMs. Then the memory controller is able to power down DIMM 1 (which is also memory channel 1). Though address remapping has described with reference to only one addressing mode here (symmetric-enhanced), in different embodiments, the remapping scheme may be extended to cover other modes such as symmetric-non-enhanced, asymmetric-enhanced and asymmetric-non-enhanced address mapping.

Furthermore, in one embodiment, the operating system and memory controller can reverse the process. In this embodiment, the operating system may make a determination that the system needs the powered down node to power back up and start normal operation again. Thus, the node is repowered and the process reverses where the memory controller remaps the memory to a symmetric enhanced mode where the addresses are once again interleaved across nodes (banks, ranks, DIMMs, etc.). The memory controller also completes the same high-speed intra or inter-memory transfers to return the data from the modified storage locations to its original locations on the repowered node.

FIGS. 3 and 4 and 3 show two identical double-sided ×8 512 Mb DIMM's, 512 MB per rank. The addressing mode is termed “Symmetric with Dynamic Paging” or “Interleaved with Enhanced Addressing.” The page size is 8K. The addresses interleave between banks 0/1 and banks 2/3 every 8K bytes. The addresses interleave between bank pairs every 512K bytes. Addresses interleave between ranks every 1024K bytes. Cache lines (denoted by CL in the figure) alternate between DIMMs every 64 bytes. FIG. 5 illustrates one embodiment of the changes in the address mapping scheme from before relocation to after relocation.

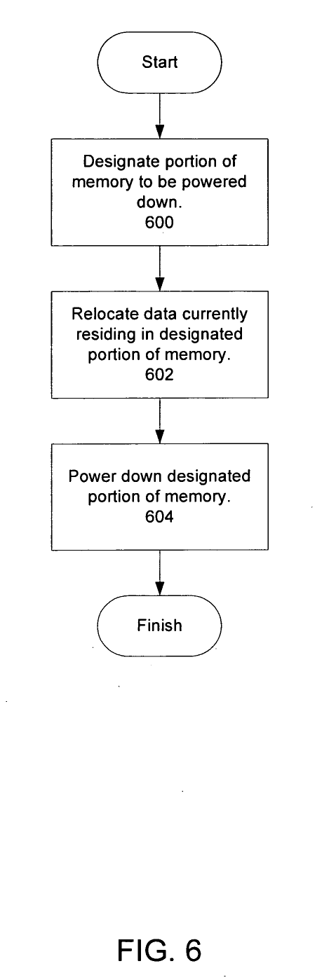

FIG. 6 is a flow diagram of one embodiment of a process to relocate data within memory to allow for a node to be powered down. The process is performed by processing logic that may comprise hardware (circuitry, dedicated logic, etc.), software (such as is run on a general purpose computer system or a dedicated machine), or a combination of both. More specifically, the process may be performed by a combination of the operating system and the memory controller within a computer system. Referring to FIG. 6, the process begins by processing logic designating a portion of memory to be powered down (processing block 600). In one embodiment, the portion of memory is an independently powered node of memory such as a DIMM, a rank, or a device within the memory subsystem of a computer system. Next, processing logic relocates the data currently residing in the designated portion of memory (processing block 602). Finally, processing logic powers down the designated portion of memory once the data has been relocated (processing block 604) and the process is finished.

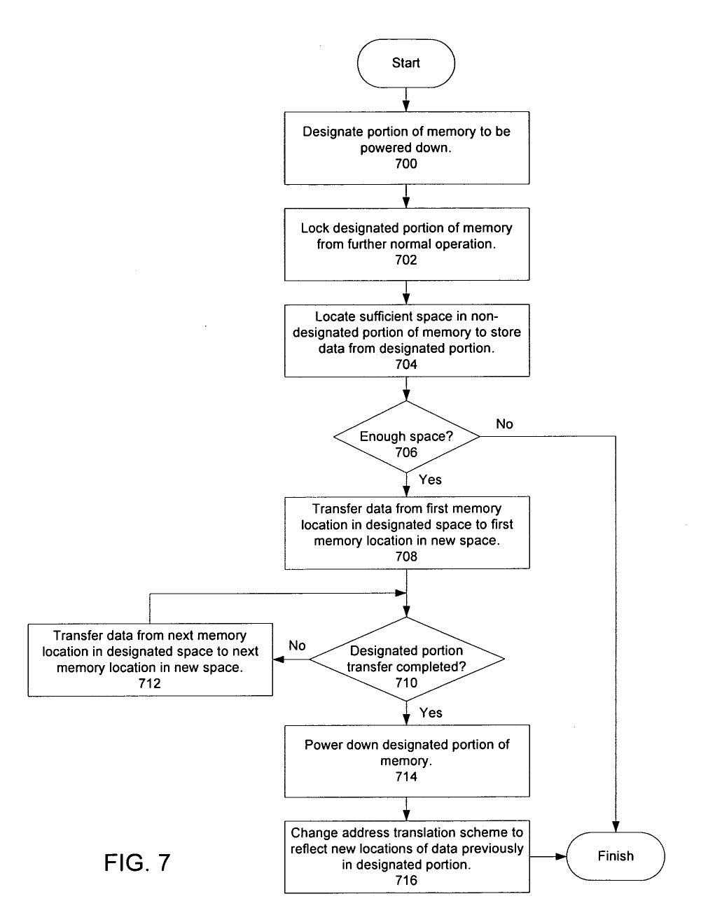

FIG. 7 is a flow diagram of another embodiment of a process to relocate data within memory to allow for a node to be powered down. The process is performed by processing logic that may comprise hardware (circuitry, dedicated logic, etc.), software (such as is run on a general purpose computer system or a dedicated machine), or a combination of both. More specifically, the process may be performed by a combination of the operating system and the memory controller within a computer system. The process begins by processing logic designating a portion of memory to be powered down (processing block 700). In one embodiment, an operating system designates a contiguous block of physical memory as the portion of memory to be powered down. In one embodiment, the contiguous block from the operating system's perspective, actually spans multiple banks, ranks, or DIMMs due to interleaved addressing. Next, processing logic locks the designated portion of memory from further normal operations (processing block 702). Next, processing logic attempts to locate sufficient space in the non-designated portion of memory to store the data from the designated portion (processing block 704). Then, processing logic determines whether enough space exists (processing block 706). In one embodiment, the operating system determines whether sufficient space exists within memory to relocate all data residing within an independently powered node to locations outside of that node. In other words, the operating system checks to see if the amount of free memory space can span at least one independently powered node. If there is not enough empty space in the non-designated portion of memory, the process is finished without any transfers or node power downs.

Otherwise, if it is determined that there is enough space in the non-designated space, then processing logic transfers the data from a first memory location in the designated space to a first memory location in the new, non-designated space (processing block 708). In one embodiment, a memory controller transfers the memory locations to free up space in the node to be powered down. In one embodiment, the memory controller is aware of the interleaved addresses and may transfer data between banks, ranks, or DIMMs to physically free up one node within memory at the physical device level. Then processing logic determines whether the designated portion of memory has completed its transfer to the non-designated portion of memory (processing block 710). If the transfer is not complete, processing logic transfers data from the next memory location in the designated space to the next memory location in the new, non-designated space (processing block 712). Block 712 repeats until all data in memory locations within the designated space have been transferred to memory locations in the non-designated space.

Finally, once the transfers have completed, then processing logic powers down the designated portion of memory (processing block 714). Then processing logic changes the address translation scheme to reflect the new locations of data previously located in the designated portion of memory (processing block 716) and the process is finished. In one embodiment, the address translation changes are reflected in FIG. 5.

Thus, embodiments of a method, apparatus, and system to manage memory power through high-speed intra-memory data transfer and dynamic memory address remapping are disclosed. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
designating a contiguous portion of the physical memory in one or more dual in-line memory modules (DIMMs) with interleaved addressing to be powered down;
locking the designated portion of memory to halt memory operations between the memory and any device that requests access to the designated portion of memory;
relocating any data currently residing in the designated portion of the one or more DIMMs to one or more locations in the non-designated portion of the one or more DIMMs; and
powering down the designated portion of the one or more DIMMs.

2. The method of claim 1, wherein the contiguous designated portion of the memory comprises an amount at least equal to a target node of the memory that is independently powered from one or more other nodes of the memory.

3. The method of claim 2, wherein relocating any data currently residing in the designated portion of the one or more DIMMs further comprises:
creating a locked contiguous block of memory of a size at least equal to the size of the target node to be powered down;
aligning the block at the starting physical address of the target node; and
relocating all memory locations within the target node to locations in memory not within the target node.

4. The method of claim 3, further comprising: dynamically remapping physical memory addresses by changing the address translation scheme to stop translations to any locations within the target node.

5. The method of claim 1, wherein relocating data from the designated portion to the non-designated portion further comprises performing one or more intra-DIMM or inter-DIMM direct transfers of data, each transfer being from a location in a first DIMM through a memory controller to either another location in the first DIMM or to a location in a second DIMM.

6. The method of claim 5, wherein the designated portion comprises an entire DIMM.

7. The method of claim 5, wherein the designated portion comprises an entire rank of devices on a DIMM.

8. The method of claim 5, wherein the designated portion comprises an entire device on a DIMM.

9. The method of claim 5, wherein the memory controller performs the relocating of memory from the target node to one or more non-targeted nodes independently from an operating system.

10. An apparatus, comprising:
memory to store an operating system, which is operable to
designate a contiguous portion of the physical memory in one or more dual in-line memory modules (DIMMs) with interleaved addressing to be powered down; and
lock the designated portion of memory to halt memory operations between the memory and any device that requests access to the designated portion of memory; and
a memory controller to
relocate any data currently residing in the designated portion of the one or more DIMMs to one or more locations in the non-designated portion of the one or more DIMMs independently from the operating system; and
power down the designated portion of the one or more DIMMs.

11. The apparatus of claim 10, wherein the contiguous designated portion of the memory comprises an amount at least equal to a target node of the memory that is independently powered from one or more other nodes of the memory.

12. The apparatus of claim 11, wherein the operating system is further operable to:
create a locked contiguous block of memory of a size at least equal to the size of the target node to be powered down; and
align the block at the starting physical address of the target node.

13. The apparatus of claim 12, wherein the memory controller is further operable to dynamically remap physical memory addresses by changing the address translation scheme to stop translations to any locations within the target node.

14. The apparatus of claim 11, wherein the memory controller is further operable to:
maintain a table of independently powered nodes; and
allow the powering down of a node if enough free memory locations are available in the non-targeted nodes in the table to create a copy of all memory locations in the targeted node in the table.

15. The apparatus of claim 10, wherein to relocate data from the designated portion to the non-designated portion further comprises to perform one or more intra-DIMM or inter-DIMM direct transfers of data, each transfer being from a location in a first DIMM through a memory controller to either another location in the first DIMM or to a location in a second DIMM.

16. The apparatus of claim 15, wherein the memory controller is further operable to relocate data from the designated portion to the non-designated portion without revealing the relocation process to the operating system.

17. A system, comprising:
an interconnect;
a central processor coupled to the interconnect;
a network interface card coupled to the interconnect;
a memory coupled to the interconnect, the memory comprising one or more dual in-line memory modules (DIMMs) with interleaved addressing;
an operating system stored within memory locations in one or more of the DIMMs, the operating system operable to designate a contiguous portion of the physical memory in the one or more DIMMs to be powered down;
lock the designated portion of memory to halt memory operations between the memory and any device that requests access to the designated portion of memory;
a memory controller coupled to the interconnect, the memory controller operable to
relocate any data currently residing in the designated portion of the one or more DIMMs to one or more locations in the non-designated portion of the one or more DIMMs independently from the operating system; and
instruct a memory power management controller to power down the designated portion of the one or more DIMMs; and
the memory power management controller to power down the designated portion of the one or more DIMMs when instructed.

18. The system of claim 17, wherein the contiguous designated portion of the memory comprises an amount at least equal to a target node of the memory that is independently powered from one or more other nodes of the memory.

19. The system of claim 18, wherein the memory controller is further operable to dynamically remap physical memory addresses by changing the address translation scheme to stop translations to any locations within the target node.

20. The system of claim 17, wherein to relocate data from the designated portion to the non-designated portion further comprises to perform one or more intra-DIMM or inter-DIMM direct transfers of data, each transfer being from a location in a first DIMM through a memory controller to either another location in the first DIMM or to a location in a second DIMM.

21. The system of claim 20, wherein the designated portion comprises an entire DIMM.

22. The system of claim 20, wherein the designated portion comprises an entire rank of devices on a DIMM.

23. The system of claim 20, wherein the designated portion comprises an entire device on a DIMM.

24. The system of claim 20, wherein the memory controller is further operable to relocate data from the designated portion to the non-designated portion without revealing the relocation process to the operating system.

25. The system of claim 17, wherein the memory controller is further operable to power on the powered down node return any relocated data to its original position in the node.

26. The system of claim 17, wherein there are multiple central processors coupled to the interconnect.
